(19) United States
(12) Patent Application Publication
(10) Pub. No.: US 2009/0309315 A1
(43) Pub. Date: Dec. 17, 2009

(54) Gasket, Particularly for the Burner of a Boiler

(76) Inventor: Giovanni Jahier, Mantova (IT)

Correspondence Address: Modiano & Associati, Via Meravigli, 16, Milan, 20123, IT

(21) Appl. No.: 12/086,188

(22) PCT Filed: Jul. 25, 2006
(86) PCT No.: PCT/EP2006/007316

§ 371 Date: Jun. 6, 2008

(30) Foreign Application Priority Data
Feb. 8, 2006 (IT) MN2006A000008

(51) Int. Cl. F16J 15/06

(52) U.S. Cl. 277/650

(57) ABSTRACT

A gasket, particularly for a burner of a boiler, comprising at least one conductor, which extends along the entire gasket and is connected to a control unit, which comprises means for generating a flow of electric current in the conductor and control means adapted to emit a signal if the flow is interrupted, the conductor being made of a material that melts in case of a rise in temperature caused by a leak of the gas contained in the boiler.

The invention relates to a gasket, particularly for the burner of a boiler.

### BACKGROUND OF THE INVENTION

It is known that gaskets are provided at the joints of monolithic elements that compose boilers, and in particular of the burner, which are adapted to prevent the external escape of the high-temperature gases contained within said boilers.

Such gaskets comprise a body made of a material that withstands high temperatures and are extremely efficient; however, it is clear that some operating defects, with consequent escape of gas, are always possible, and therefore the aim of the present invention is to provide a gasket that indicates immediately at the onset any leak, allowing prompt response.

### SUMMARY OF THE INVENTION

The proposed aim is achieved by a gasket, particularly for a burner of a boiler, according to the invention, which comprises a body made of a material adapted to provide a seal for high-temperature gases, characterized in that it comprises at least one conductor, which extends along the entire gasket and is connected, at its two ends, to a control unit, which comprises means for generating a flow of electric current in said conductor and control means adapted to emit a signal if the flow is interrupted, said conductor being made of a material that melts in case of a rise in temperature caused by a leak of the gas contained in the boiler.

### BRIEF DESCRIPTION OF THE DRAWINGS

Further characteristics and advantages of the present invention will become better apparent from the description of some preferred but not exclusive embodiments thereof, illustrated by way of non-limiting example in the accompanying drawings, wherein:

FIG. 1 is an exploded view of a gas-fired boiler which comprises a burner provided with a gasket according to the invention;

FIG. 2 is a schematic plan view of the gasket;

FIG. 3 is a sectional view of the gasket, taken along the line III-III of FIG. 2;

FIGS. 4, 6, 8 are schematic plan views of gaskets according to variations;

FIGS. 5, 7, 9 are respectively sectional views of the gasket, taken along the line V-V of FIG. 4, along the line VII-VII of FIG. 6, and along the line IX-IX of FIG. 8.

### DESCRIPTION OF THE PREFERRED EMBODIMENTS

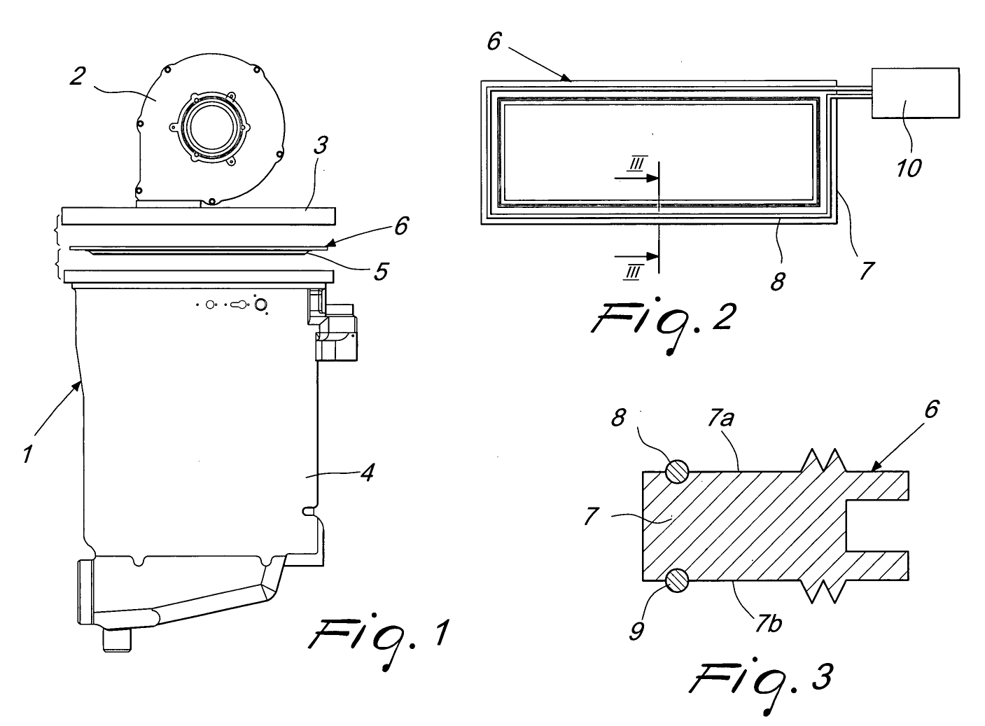

With reference to FIGS. 1, 2, 3, the reference numeral 1 generally designates a gas-fired boiler, which comprises a fan 2, a unit 3 for distributing the mixture of combustible gas and oxidizing air, and a heat exchanger 4, where the exhaust gases produced by combustion release heat to the water to be heated.

The burner 5 is inserted in a known manner between the distribution unit 3 and the exchanger 4 and is provided, at its peripheral region, with a gasket according to the invention, generally designated by the reference numeral 6.

The gasket 6 comprises the body 7, which is made of a per se known material adapted to provide a seal for high-temperature gas, and further comprises two conductors 8 and 9, which are inserted respectively within the two faces 7a, 7b of the body 7 where the gas seal is provided.

The conductors 8 and 9 are connected at their ends to a control unit 10, which comprises means adapted to generate a flow of electric current in said conductors and also comprises control means adapted to emit a signal if the flow is interrupted.

The conductors 8 and 9 are made of a material that melts if it reaches a temperature such as might occur in the presence of a leak of the high-temperature gas contained in the boiler which, in its path in the region where the seal provided by the gasket fails, strikes the conductors; therefore, in case of a gas leak, it is sufficient for one of the two conductors 8 and 9 to melt in order to interrupt the flow of electric current.

Consequently, the control means provided within the control unit 10 intervene immediately by emitting a signal, which can block the burner, and optionally an alarm.

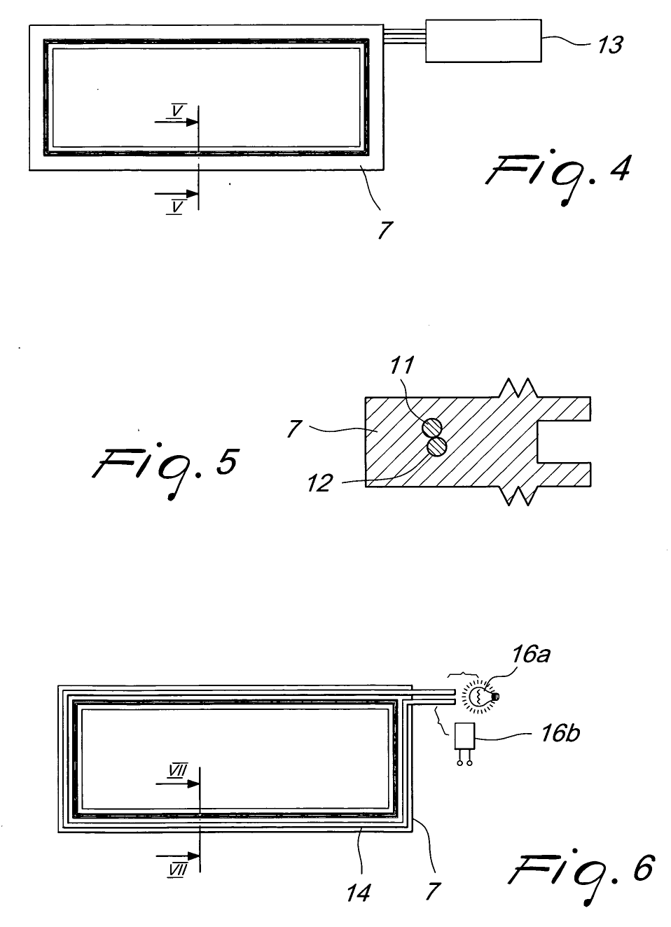

FIGS. 4 and 5 are views of a first variation of the invention, which provides for the presence of two conductors 11 and 12, which are inserted in mutual contact within the body 7 of the gasket and are connected at the ends to a control unit 13, which comprises means adapted to generate a flow of electric current in said conductors, and also comprises control means adapted to emit a signal if the flow is interrupted.

The conductors 11 and 12 are made of a material that melts if it reaches a temperature equal to the temperature reached by the body 7 of the gasket in case of a gas leak, consequently producing a short-circuit and an interruption of the flow of electric current, which is detected by the control means of the control unit 13, which immediately emit a signal for blocking the burner and optionally an alarm signal.

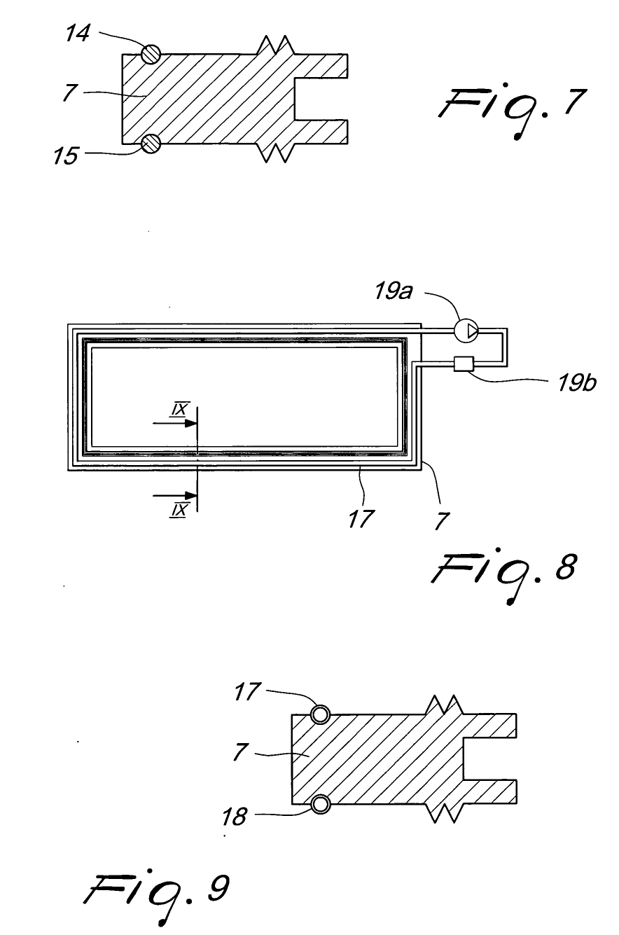

Another variation is shown in FIGS. 6 and 7: in such figures, conductors 14 and 15 are provided by means of optical fibers, which melt if gas leaks from the boiler, and said optical fibers are connected to a control unit, which comprises a light source 16a and control means 16b adapted to emit a signal if the flow is interrupted, as described hereabove.

In the variation shown in FIGS. 8 and 9, conductors 17 and 18 are provided by means of tubes which are adapted to convey a flow of fluid circulated by means 19a contained in a control unit, which also comprises means 19b adapted to emit a signal if the flow is interrupted.

The tubes 17 and 18 are made of a material that melts if it is struck by a leak of gas, and the consequent interruption of flow is detected by the means 19b.

The described invention is susceptible of numerous other modifications and variations, all of which are within the scope of the appended claims; all the details may further be replaced with other technically equivalent elements.

The disclosures in Italian Patent Application No. MN2006A000008 from which this application claims priority are incorporated herein by reference.

What is claimed is:

1-5. (canceled)

6. A gasket, particularly for a burner of a boiler, comprising a body made of a material adapted to provide a seal for high-temperature gases, characterized in that it comprises at least one conductor, which extends along the entire gasket and is connected, at its two ends, to a control unit, which comprises means for generating a flow of electric current in said conductor and control means adapted to emit a signal if the flow is interrupted, said conductor being made of a material that melts in case of a rise in temperature caused by a leak of the gas contained in the boiler.

7. The gasket according to claim 6, comprising two conductors, which are inserted respectively within two faces of the gasket where the gas seal is provided, said conductors being connected at their two ends to said control unit.

8. The gasket according to claim 6, wherein said conductors are provided by means of optical fibers connected, at their ends, to said control unit, which comprises a light source.

9. The gasket according to claim 6, wherein said conductors are provided by means of tubes, which are adapted to convey a flow of fluid and are connected at their ends to said control unit, which comprises means adapted to generate the circulation of said fluid.

10. The gasket according to claim 6, further comprising two conductors, which are inserted in mutual contact within the body of the gasket, said conductors being connected at their two ends to said control unit.
